(19) United States
(12) Patent Application Publication
(10) Pub. No.: US 2018/0099361 A1
(43) Pub. Date: Apr. 12, 2018

(54) APPARATUS AND METHOD FOR FASTENING INSULATION

(71) Applicant: Gripnail Corporation, East Providence, RI (US)

(72) Inventors: David Fleet ASHTON, Riverside, RI (US); Louis Steven COSTA, Bristol, RI (US); Christopher Allan RYDING, Taunton, MA (US); Anthony David OLIVER, Riverside, RI (US)

(73) Assignee: Gripnail Corporation, East Providence, RI (US)

(21) Appl. No.: 15/727,230

(22) Filed: Oct. 6, 2017

Related U.S. Application Data
(60) Provisional application No. 62/406,233, filed on Oct. 10, 2016.
(60) Provisional application No. 62/503,734, filed on May 9, 2017.

(51) Int. Cl. B23K 37/02; B23K 11/00

(52) U.S. Cl. CPC B23K 37/0211; B23K 11/0046; B23K 37/0241

(57) ABSTRACT

Apparatus and methods for fastening insulation to a metal panel are disclosed. One apparatus includes a frame; a capacitor discharge welder; a panel support bar, preferably being non-marring of a metal panel; a hopper for receiving weld pins and the weld pins; PLC controls; and a grounding clamp. Another apparatus includes a weld table, a weld pin hopper, a weld head, a welder power supply, a carriage for the weld head, a motor for moving the weld head on the carriage and a motor for moving the carriage the length of the weld table.

### RELATED APPLICATION

This Application claims benefit of U.S. Provisional Application Ser. No. 62/406,233, filed Oct. 10, 2016, entitled “Apparatus and Method for Fastening Insulation,” and U.S. Provisional Application Ser. No. 62/503,734, filed May 9, 2017, entitled “Apparatus And Method For Fastening Insulation,” and both applications being incorporated herein by reference in their entirety.

### FIELD OF THE INVENTION

The present invention relates to an apparatus and method for fastening insulation to an object. More particularly, the invention relates to an apparatus and method for fastening insulation having a foil or membrane facing to metal panels, including painted metal surfaces.

### BACKGROUND OF THE INVENTION

Manufacturers of air conditioning and air handling devices prefer to construct the outside shell of their units from metal that has been painted or coated prior to fabrication. This prepainted metal is purchased in sheets or coils and processed through blanking, stamping and shearing to form shapes that will fit together and become the external casing for air conditioners or air handling devices. This metal may also be painted after blanking, stamping, shearing and before or after fabrication. This metal may be painted on one or both sides. These casings are typically painted on the outside and insulated on the inside with foil faced fiberglass blankets, which have been precut to match the configuration of the prepainted metal panels. There are currently about six ways to fasten this insulation, namely: (1) the insulation is adhered to the inside of the panel with a layer of hot melt adhesive, water cured adhesive, or air cured adhesive. All of these methods have a limited “tack time” for applying the insulation and this slows down the production time. Quality control is also difficult because multiple sizes of panels usually require hand spraying, rolling or brush application of adhesive; (2) the insulation may be attached with a GRIPNAIL® brand mechanical fastener. This method works well when the base metal is thicker than 24 gauge. However, the impact of applying these fasteners may leave markings on the painted outside surface of thinner metal casing panels; (3) an adhesive based insulation hanger may be used to affix a spindle, the insulation may then be impaled over the spindle and retained with a washer. This is a three step method that tends to be less than permanent because the adhesive is pressure sensitive and the fasteners are hand applied; (4) a spindle anchor may be used to affix the spindle. The insulation may then be impaled over the spindle and retained with a washer. These fasteners require liquid adhesive and up to 24 hours of drying time for water based adhesives. Solvent based adhesives may also be used to attach spindle anchors, however, these adhesives may be flammable and require ventilation during the curing process; (5) a capacitor discharge weld pin may be used to affix a spindle. The insulation may then be impaled over and retained with a washer. This is still a three step process and time consuming; and (6) GRIPNAIL® POWERPOINT brand resistance weld pins may be applied to attach the insulation to the metal panel. However the application of resistance weld pins may create excessive heat which could mar the painted exterior surface of the sheet metal casing panel. In addition, the application of resistance weld pins typically use an electrical ground placed on the exterior side of the panel opposite the application of the weld pin. This method does not work if the exterior panel paint acts as an insulator.

These devices and methods have various shortcomings as set forth above, including being time consuming, adding expense to the manufacturing process and leaving markings on the painted metal panels. These and other shortcomings of these devices and methods are addressed by the present invention.

### SUMMARY OF THE INVENTION

A primary object of the present invention is to provide an apparatus and method for fastening insulation to an object.

Another primary object of the present invention is to provide an apparatus and method for fastening fiber glass or foam insulation having a foil or membrane facing to painted metal panels.

Another primary object of the present invention is to provide an apparatus and method for fastening fiber glass or foam insulation having a foil or membrane facing to metal painted panels using an apparatus having a panel support bar for the painted metal panel and an automatic apparatus having a hopper with weld pins for fastening the insulation to the painted metal panel.

Another primary object of the present invention is to provide a new and unique grounding clamp for use with the apparatus and method of the invention.

Another primary object of the invention includes a device for applying weld pins to fasten insulation to sheet metal panels, including automatically feeding, positioning and applying weld pins anywhere in the field of a weld table.

The present invention comprises an apparatus comprising a frame; a capacitor discharge welder; a panel support bar, preferably being non-marring of a metal panel; a hopper for receiving weld pins and the weld pins; PLC controls; and a grounding clamp.

The present invention further comprises an apparatus for fastening insulation to a painted metal panel, the apparatus including a frame, a non-marring panel support bar attached to the frame and adapted to receive the painted metal panel, a hopper for receiving weld pins and a plurality of weld pins in the hopper and adapted to be fed to a drive head to fasten the insulation to the metal panel, a capacitor discharge welder removeably connected to the frame, and a ground clamp connected to the capacitor discharge welder and adapted to be connected to the painted metal panel; wherein a weld pin is supplied to the drive head and the drive head inserts the weld pin into the insulation and connects the insulation to the painted metal panel without marring the paint of the painted metal panel.

The present invention is further directed to a process for attaching insulation to a painted metal panel comprising the steps of (a) providing a painted metal panel with an unattached piece of insulation on a non-marring support member of an apparatus for fastening the insulation to the painted metal panel by a weld pin; (b) attaching a ground clamp to the painted metal panel or through an aperture in the painted metal panel, the ground clamp comprising a handle and first and second clamp ends, the first clamp end including a plastic member for ground and the second clamp end including a metal tip end adapted to pass through an aperture in the painted metal panel and engage the plastic member or clamp to a portion of the painted metal panel; (c) positioning the painted metal panel with the unattached piece of insulation under a drive head of the apparatus for fastening the insulation to the painted metal panel and which is connected to a capacitor discharge welder; (d) supplying a weld pin to the drive head of the apparatus; (e) welding the weld pin to the painted metal panel to fasten the insulation to the painted metal panel; and (f) repeating steps (a) through (e) a sufficient number of times to fasten the insulation to the painted metal panel, and wherein the fastening operation will not leave markings on the exterior side of the painted metal panel.

Another embodiment of the present invention comprises a weld table, a hopper for weld pins, a weld head which positions the weld pin through the insulation such that the weld pin is in contact with a painted metal panel to which insulation is to be attached, a welder power supply, a carriage which includes a weld head, a motor which moves the weld head the length of the carriage, and a motor which moves the carriage the length of the weld table. This embodiment of the invention may be used in a process for attaching insulation to a painted metal panel, comprising the steps of filling the hopper with weld pins; placing both a painted metal panel and a piece of insulation on the weld table; activating a computer controlled program to position the weld head in a defined location; sending a signal to the weld head to position the weld pin; transferring an electrical charge from the welder power supply to the weld pin fastening the weld pin through the insulation to the painted metal panel; and once the weld is completed repositioning the weld head for the next weld pin or returning the weld head to its home position.

The welding apparatus and method work very well with prepainted metal. The invention requires a minimum amount of energy to form a robust bond. This reduced energy creates less heat, which is why the paint does not discolor. The invention provides for an efficient transfer of energy from the welder to the point of attachment. Unlike many welding systems, particularly resistance welding systems, which simply add more energy to overcome the inefficiencies in the transfer of energy, the invention controls these inefficiencies such that less energy is required for a connection. The following improvements are believed to contribute to the overall efficiency of the fastening system, including the use of less energy: (1) the interface between the weld pin cap and upper weld tip is maximized for electrical conductivity; (2) the mechanical connection between the weld pin shank and weld pin cap is maximized for electrical conductivity as well as precise dimensional stability; (3) each weld pin has a dielectric material adhered to the underside of the cap. This assures that welding energy is not dispersed into the foil facing of the insulation; (4) the weld pin point is designed and manufactured to exact tolerances, so a minimum amount of energy is used to make the connection; (5) the ground side of the weld circuit provides a unique positive connection, without loss of energy; and (6) the drive head may apply pressure in two stages. The first stage gently positions the point of the weld pin against the inside of the metal casing in such a way that the point of the weld pin pierces the paint but is not blunted and the outside of the metal casing is not deformed. The second stage applies a precise amount of force to push the weld pin point into the molten metal while welding.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 is a side perspective view of the apparatus of the present invention.

FIG. 2 is an opposite side view of the apparatus of FIG. 1.

FIG. 3 is a close-up view of the welder and controls of the apparatus of FIG. 1.

FIG. 4 is a close-up side view of the weld pin hopper and the weld pin supply track of the apparatus of FIG. 1.

FIG. 5 is a close-up view of the drive head, the panel support bar and the weld pin supply track showing the weld pins in the track of the apparatus of FIG. 1.

FIG. 6 is a perspective view of the grounding clamp of the apparatus of FIG. 1.

FIG. 7 is a prepainted metal panel and showing the ground clamp connected to the panel through an aperture in the panel and partially showing a piece of insulation.

FIG. 8 is a cross-sectional view of the panel and grounding clamp of FIG. 7.

FIG. 9 is a metal panel prepainted on the outside and not on the inside and showing the grounding clamp connected to each side of the panel and not through an aperture in the panel.

FIGS. 10A and 10B are perspective views of a cupped head weld pin, with dielectric coating adhered to the underside of the cap, useful with the apparatus of FIG. 1.

FIG. 11 is a side view of the weld pin of FIGS. 10A and 10B.

FIG. 12 is a prepainted metal panel with insulation (partially shown) having a foil facing prior to fastening to the prepainted metal panel and positioned on the apparatus of FIG. 1.

FIG. 13 illustrates the steps of welding the weld pin to fasten the insulation.

FIG. 14 is a close up view of a portable capacitor discharge welder with the weld gun and grounding clamp.

FIG. 15 is another embodiment of the invention including a weld table.

### DETAILED DESCRIPTION OF THE PREFERRED EMBODIMENTS

The present invention is directed to apparatus and methods for fastening insulation to objects, and particularly metal panels, using a capacitor discharge welder. The apparatus and methods of the present invention provide a more efficient and less expensive apparatus and method for fastening insulation to painted metal panels, including without marring or damaging the exterior painted surface. For purposes of the description of the invention, the invention will be described for fastening fiber glass or foam insulation having a foil or membrane facing to a painted metal panel. Such painted metal panels may include, but are not limited to, panels for an air conditioner, a furnace, an air handler or other insulated appliance panel.

The apparatus and methods of the invention automatically fastens the insulation to the metal panels using cupped head weld pins with dielectric coating. The invention replaces the use of messy adhesive or expensive internal bracings by the use of capacitor discharge welding utilizing a hopper fed insulating apparatus. The invention speeds up the process for fastening insulation to metal panels and provides more reliable apparatus and methods for fastening insulation to metal panels. The weld pins may be used alone or in conjunction with an adhesive. If used with an adhesive, the weld pins provide a secure attachment while the adhesives cures. This speeds the production process.

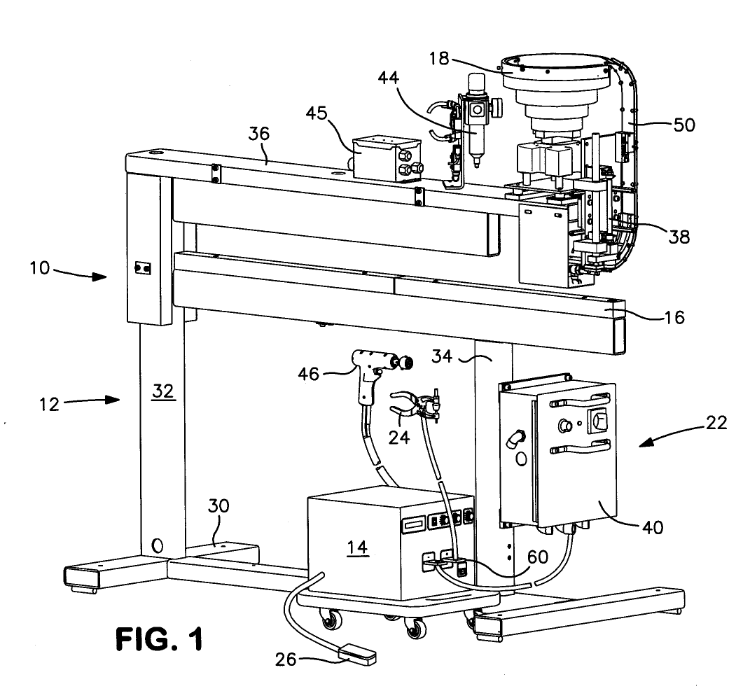

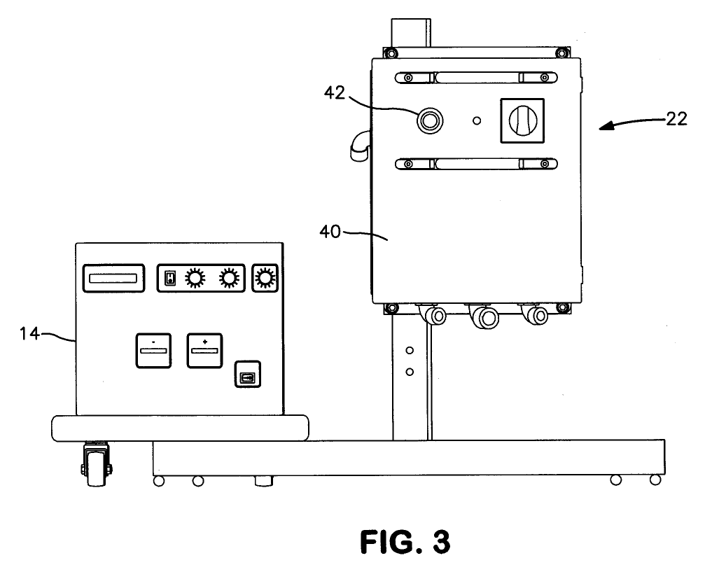

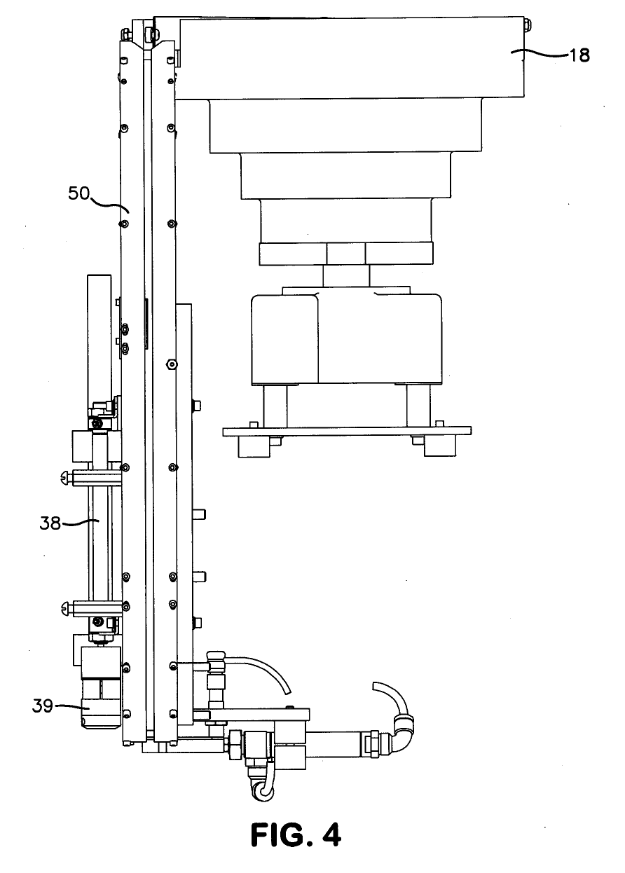

Referring to FIGS. 1-14, the primary components of the apparatus 10 invention includes a frame 12; a capacitor discharge welder 14; a panel support bar 16, preferably being non-marring of a metal panel; a hopper 18 for receiving weld pins 20; PLC controls 22; and a grounding clamp 24. These components will now be described in further detail.

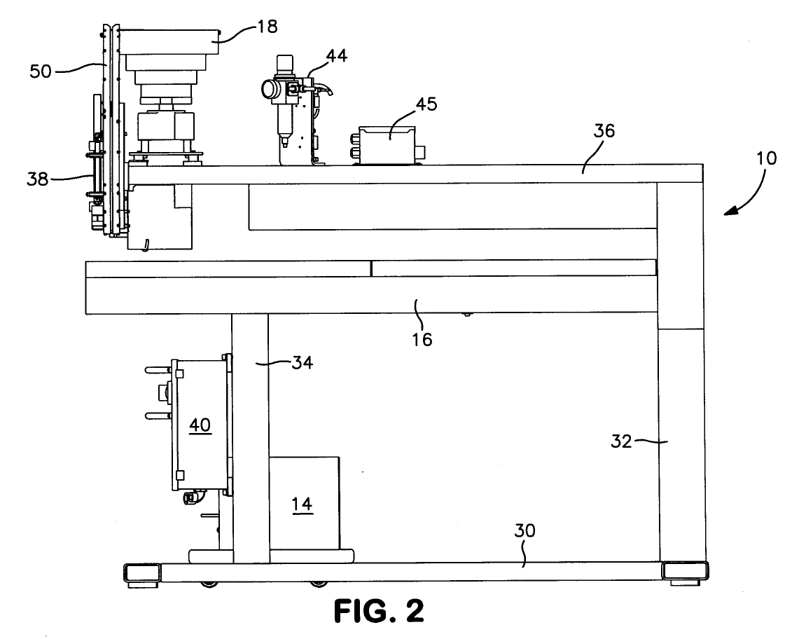

Referring to, for example, FIGS. 1 and 2, frame 12 is preferably a steel frame. The frame comprises an I-shaped base 30, vertical support members 32 and 34, and horizontal support member 36. Support member 36 includes hopper 18 and a drive head 38, and is similar to the GRIPNAIL® POWERPINNER 7005 which is incorporated herein by reference, including the additional components. Frame 12 has connected to it a capacitor discharge welder (“CDW”) 14 and which is detachable as discussed below. PLC controls 22 are in an electronics box 40 with potentiometer 42 and attached to support member 34 of the frame 12. There is an air supply regulator 44 and an electrical junction box 45 for connecting the electrical components in box 40 to the electrical components on support member 36.

The capacitor discharge welder 14 may be a GRIPNAIL® POWERPINNER 7310 or similar welder. The CDW may provide two stages or pulses when welding a weld pin 20. A first pulse is applied after the weld pin point contacts the sheet metal and pierces any paint or protective coating. This first pulse clears away any particulate paint, and a second pulse welds the weld pin 20 to the panel as discussed below. The CDW is activated by a signal sent from a foot pedal 26 as discussed below. Referring to FIGS. 1 and 14, the CDW 14 may be equipped with a portable weld gun 46 and ground clamp 24 and may be detachable from the frame 12 to move around the shop and work on larger panels or objects which may not fit on the support bar 16 of apparatus 10.

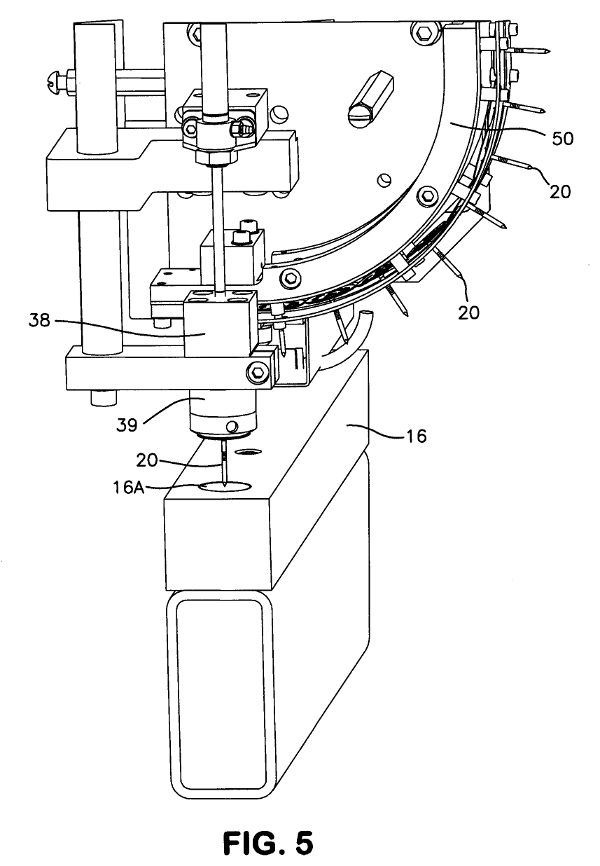

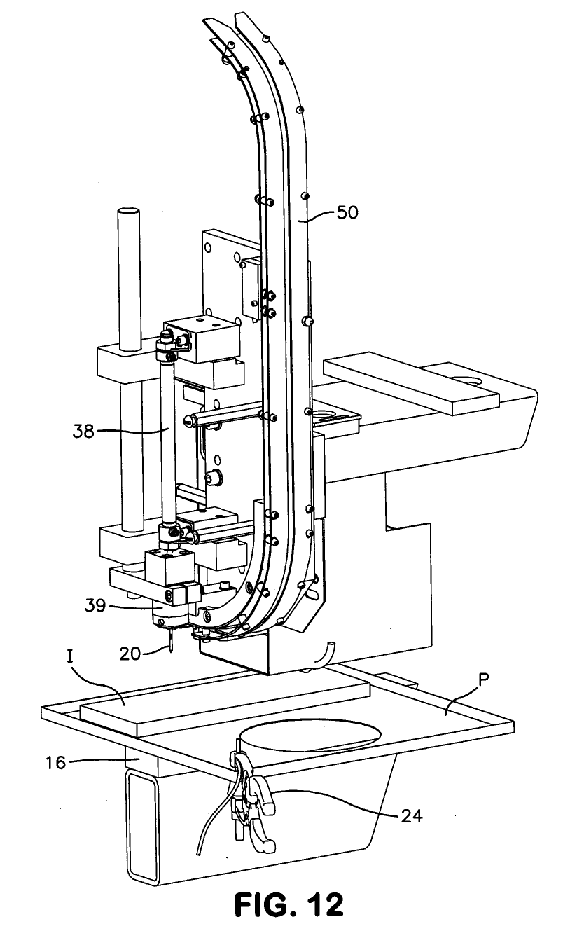

The panel support bar 16 comprises a horizontal support for receiving the sheet metal panel with insulation overlying the panel as shown, for example, in FIGS. 1, 2 and 12. FIG. 12 shows a metal panel P on support bar 16 and partially shows a piece of insulation I which normally covers the entire metal panel P and in preparation for fastening the insulation I to the metal panel P. The support bar is constructed and arranged to support the panel during the process of fastening the insulation to the panel. The support bar is preferably made of a non-marring material to avoid marring or creating marks or otherwise damaging the painted metal panel when fastening the insulation to the panel. The support bar may be made of an ultra-high molecular weight (UHMW) plastic, to support the painted side of the painted metal panel. This reduces the chance of scratching or marring the metal panel. Referring to FIG. 5, the support bar 16 has a metal insert 16A which provides a wear resistance contact point to support the metal panel at the point of welding. Additional support members or a free standing table may be used to support the metal panel at its outer edges. It is understood that these other panel supports or free standing tables may also include a non-marring surface.

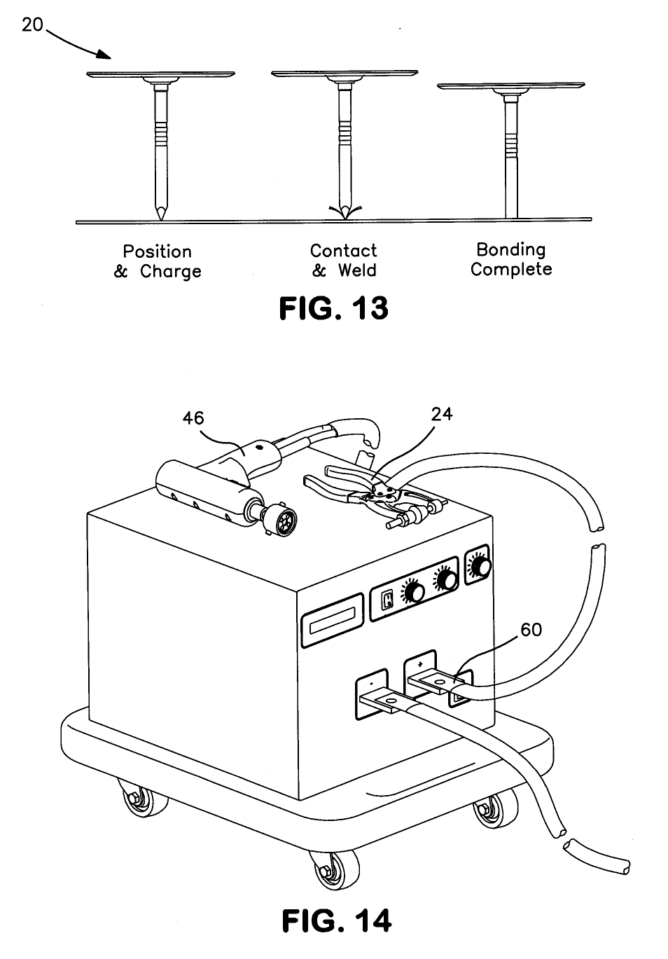

The hopper 18 receives a plurality of weld pins 20, e.g. 1000 weld pins. The hopper is a vibratory hopper for dispensing the weld pins to a drive head 38, such as used on the GRIPNAIL® POWERPINNER 7005 apparatus. As seen, for example, in FIGS. 1, 2, 4 and 5, the weld pins 20 are moved from hopper 18 by vibration to drive head 38 on a track 50. For illustration, FIG. 5 shows the weld pins 20 in the track 50 (the weld pins 20 are not shown in the track 50 in the other Figures for simplicity, although they would appear as in FIG. 5). The drive head 38 includes an upper weld tip 39 as best seen in FIG. 5. Referring to FIG. 13, the drive head 38 operates in two stages. The upper weld tip 39 first engages the head of weld pin 20 and punches the weld pin 20 through the insulation (not shown in FIG. 13) and any interior paint on the metal and then contacts the metal panel. In the second stage, the upper weld tip 39 puts pressure on the weld pin 20 to firmly seat on the metal panel and at this point a first pulse of the CDW is activated to clear out any paint. Then a second pulse of the CDW welds the weld pin 20 to the panel. In some cases, only a single pulse may be required.

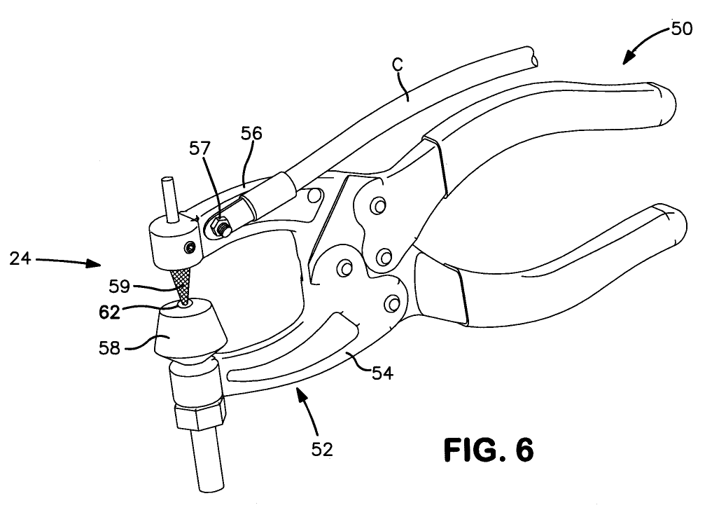

The grounding clamp 24 is shown, for example, in FIGS. 1 and 6. Referring to FIG. 6, the grounding clamp includes a handle end 50 and clamp end 52 having clamping members 54 and 56. There is a connecting member 57 for connecting a cable C to a ground member 60 of the CDW 14 to ground the apparatus when using the CDW. The cable C is attached to clamp member 56 as discussed further below. The ground clamp 24 is preferably attached to a sheet metal panel P with members 54 and 56, member 54 including a plastic member 58 for grounding and engaging a metal tip end 59. The cable C is most preferably attached to the metal tip end side 56 of the grounding clamp to provide a direct electrical connection between the CDW 14 and the metal tip end 59. This has been found to provide the most efficient passage of energy during the welding process and energy may be lost if the cable C is attached at a different location of the clamp 24.

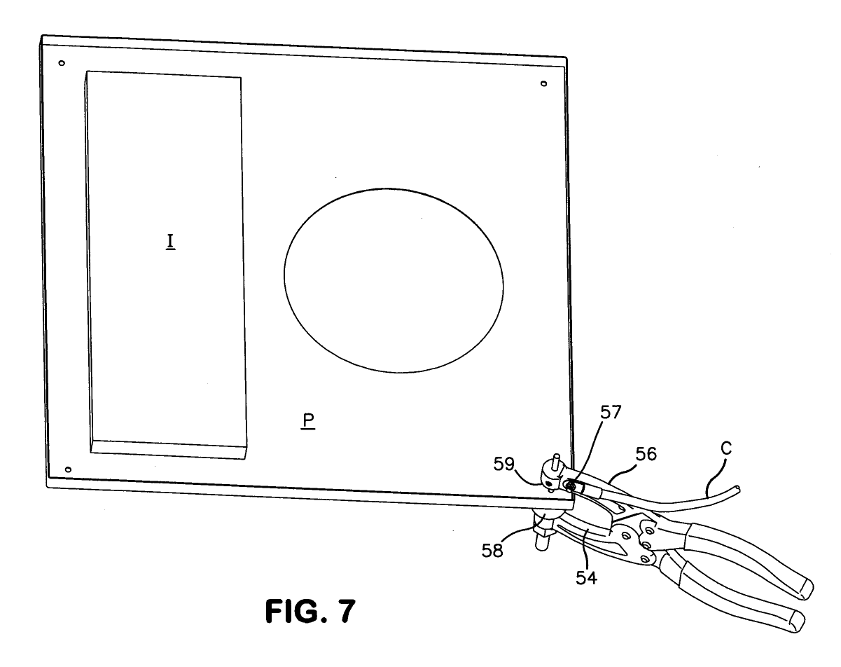

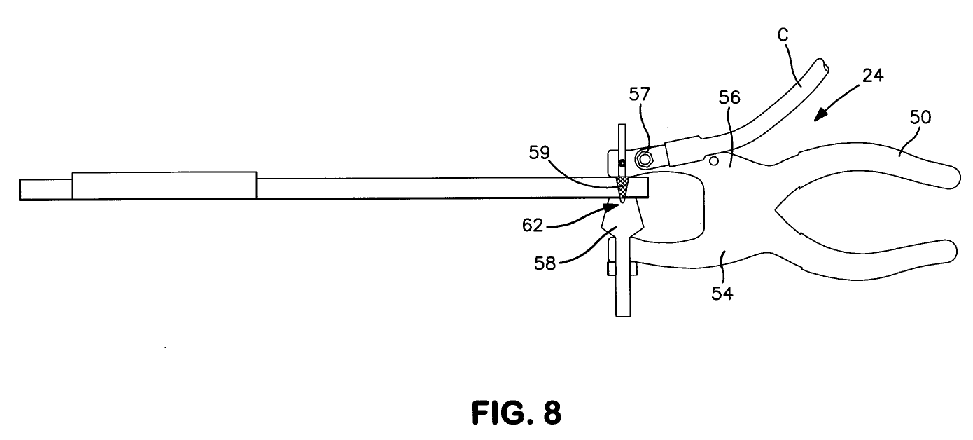

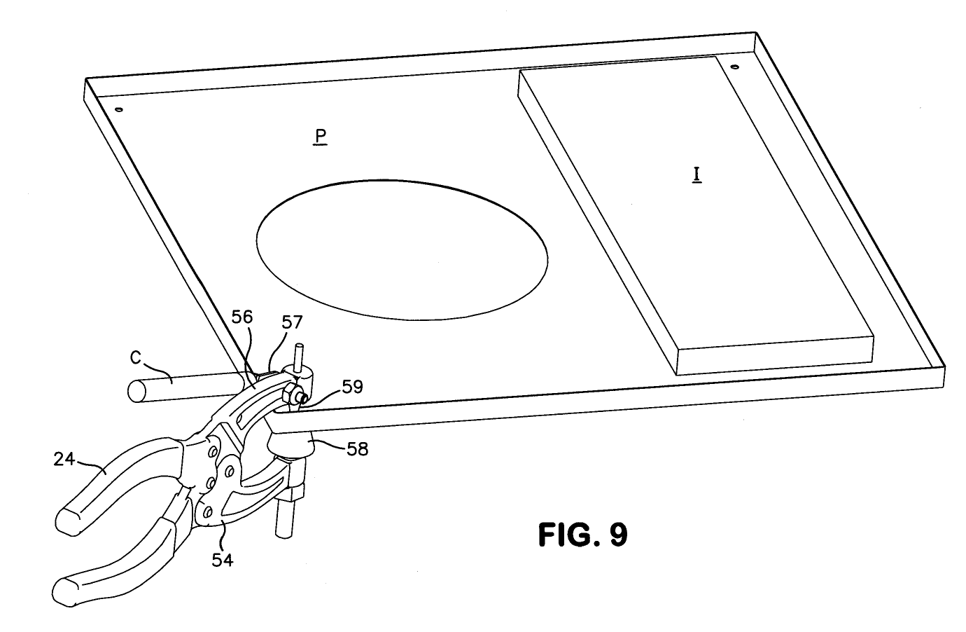

In a preferred embodiment, metal tip 59 may have a knurled outer surface and plastic member 58 includes an aperture 62 for receiving metal tip 59 as seen in FIGS. 6 and 8. In a preferred method and as shown in FIGS. 7 and 8, sheet metal panels are made with an aperture in the panel and member 59 extends through the panel aperture and the knurled edge of member 59 deforms the inside diameter of the aperture with its knurled edge, which provides maximum surface contact for the weld ground. During this process the panel may be supported by member 58, as shown in FIGS. 7, 8 and 12. In the alternative, the grounding clamp 24 is attached to the sheet metal surface as shown in FIG. 9 when the inside surface of the metal panel is unpainted and there is no aperture.

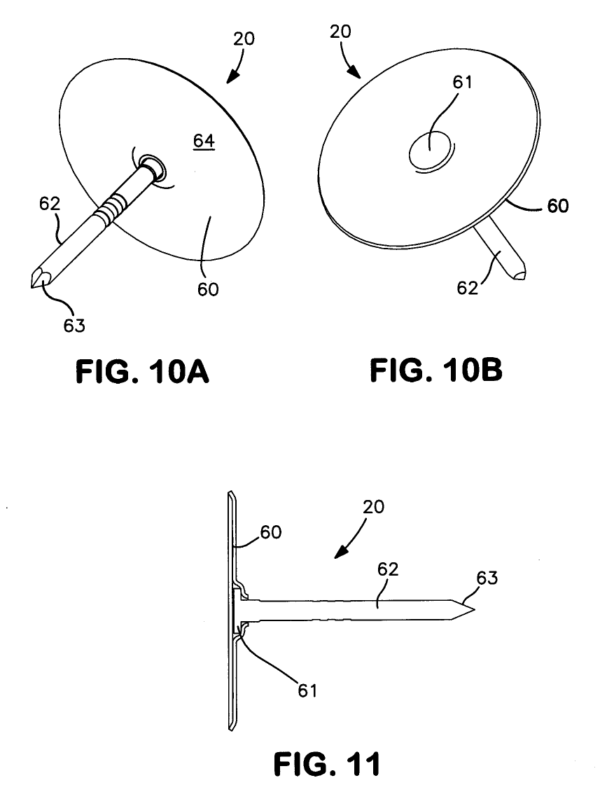

Referring to FIGS. 10A, 10B and 11, the weld pins 20 comprise a cupped head weld pin. The cupped head weld pins provide for a single robust fastener. The precise attachment of cap 60 and to pin head 61 with shank 62 allows for better contact when welding, and a dielectric coating 64 on the underside of the cap acts as a superior insulator over traditional paper washers. The dielectric coating 64 substantially reduces arcing when fastening foil face insulation. Various size cupped head weld pins may be used, including lengths from ¼″ to 4″ and cap diameters from 1″ to 1 ½″. The cupped head weld pins permanently attach insulation to metal in one easy step. They can be applied using 110 volt capacitor discharge welding. The fastener head 60, head 61 and shank 62 and point 63 are manufactured from a carbon alloy steel. A galvanized or electroplated steel retaining cap 60 is mechanically affixed to the driven end of the fastener. These weld pins provide for (1) better welds—forged diamond point design creates more electrical resistance for better welds; (2) a very sharp point 63—pierces through the insulation and paint to provide a positive electrical contact; and (3) beveled edge cap 60—depresses the surface of insulation without tearing or cutting of insulation. The cupped head capacitor discharge weld pins 20 function properly over the normally accepted operating range of temperatures of 32° F. to 250° F. and are not adversely affected to temperatures of 0° F. to 550° F.

Referring to FIG. 13, there is shown an illustration of how the cupped head weld pins 20 work. Referring, for example, to FIGS. 5, 12 and 13, the upper weld tip 39 of the CDW 14 fits flush on the head of the pin 20. Preferably, the upper weld tip 39 and weld pin cap 60 nest together to eliminate any arcing between the two, thereby avoiding black carbon marks. This interface is important because black markings may occur if there are any gaps between the weld tip 39 and the pin cap 60. As noted above, in a preferred embodiment, the CDW may provide two pulses during the welding process.

The PLC controls comprise standard PLC controls such as used with the GRIPNAIL® POWERPINNER 7005 and which is incorporated herein by reference.

The process of using the apparatus of the invention may be described as follows: the CDW has been engineered to fasten foil or membrane faced insulation to prepainted sheet metal panels. The apparatus combines the automatic feeding and reliability of hopper fed resistance welders with an advanced capacitor discharge welding system capable of fastening 40 or more cup head insulated weld pins 20 per minute. The apparatus eliminates the messy time-consuming application of adhesives or the expense of specially engineered internal bracing. The basic apparatus operation is simple. The operator first attaches the ground clamp 24 to the sheet metal panel and then positions the sheet metal panel and insulation under the drive head 38 and activates the foot pedal 26. Each time the foot pedal 26 is activated the weld tip 39 engages a cup head weld pin 20 which is pushed through the insulation and interior painted and/or galvanized surface, until the tip of the point contacts the underlying metal of the panel. Then an instantaneous discharge of electricity permanently welds the tip of the cupped head weld pin to the sheet metal panel. The fastening happens so quickly that the sheet metal remains cool to the touch and the exterior painted surface is not disturbed. After all the pins 20 have been applied the operator removes the ground clamp 24. The hopper 18 will hold up to 1000 weld pins. The CDW runs on 115 VAC and air consumption is less than one-third SCFM. The painted finish on the panel is protected by the plastic non-marring support bar 16. The apparatus 10 controls are simple: air pressure is controlled with a regulator 44 and the speed of the vibratory bowl 18 is controlled with a potentiometer 42. The weld control timing is done at the power unit control panel 40. The weld power output is controlled at the CDW.

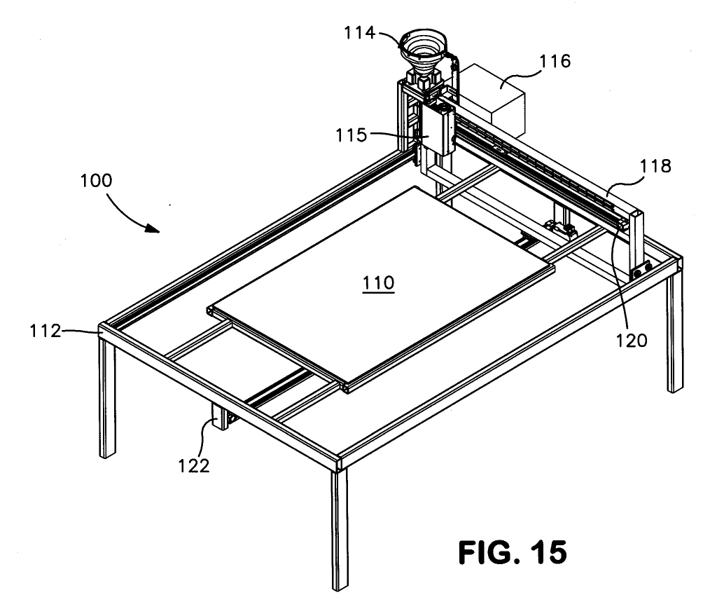

Referring to FIG. 15, there is shown an alternate apparatus and method for fastening insulation to a metal panel. In one embodiment, the insulation includes a foil backing and the metal panel is a painted metal panel. It is understood that the apparatus and method shown in FIG. 15 may use various aspects of the apparatus and method shown in FIGS. 1-14 and these aspects of the invention are not repeated herein in detail. For example only, while not shown, this embodiment will use the ground clamp 24 and the two stage process of inserting the weld pin.

Referring again to FIG. 15, there is shown an apparatus 100 for automatically feeding, positioning and applying weld pins anywhere in the field of a weld table. The apparatus comprises weld table 110 which sits on a weld table frame 112; a hopper 114 for weld pins 20; a weld head 115 which positions the weld pin 20 through the insulation until the point of the weld pin 20 is in contact with a metal panel; a welder power supply 116; a Y-carriage 118 which serves as a mount for the weld head 115; a Y-axis servo motor 120 which propels the weld head the length of the Y-carriage 118; and an X-axis servo motor 122 which propels the Y-carriage 118 and travels the length of the weld table frame 112. In operation, the operator will fill the hopper 114 with weld pins 20 and place both a metal panel and a piece of insulation on the weld table 110. A ground clamp 24 is attached to the metal panel (not shown). The operator will then activate a computer controlled program to position the weld head 115 in the proper location. A signal is then sent to the weld head to position the weld pin 20 and transfer an electrical charge from the welder power supply to the weld pin 20. Once the weld is completed the weld head 115 will reposition for the next weld pin or return to its home position.

Variations of the apparatus 100 include, but are not limited to, the weld head may transfer one or multiple weld pins; the weld head may also contain the hopper and welder power supply; and the hopper may remain stationary and the weld head may return to the hopper to refill the weld pins.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. An apparatus for fastening insulation to a painted metal panel, said apparatus comprising
a frame,
a non-marring panel support bar attached to said frame and adapted to receive said painted metal panel,
a hopper for receiving weld pins attached to said frame and a plurality of weld pins in said hopper and adapted to be fed to a drive head to fasten said insulation to said painted metal panel,
a capacitor discharge welder removeably connected to said frame,
a drive head for fastening said insulation to said painted metal panel attached to said frame, and
a ground clamp connected to said capacitor discharge welder and adapted to be connected to said painted metal panel,
wherein a weld pin is supplied to said drive head and said drive head inserts said weld pin into said insulation and connects said insulation to said painted metal panel without marring the paint of said painted metal panel.

2. An apparatus for fastening insulation to a painted metal panel according to claim 1 wherein said weld pin fastens said insulation to said painted metal panel in a two stage process comprising (a) punching the weld pin through the insulation and any paint on the painted metal panel and then contacting the metal panel and (b) said drive head puts pressure on said weld pin to seat said weld pin on said painted metal panel and to receive two pulses from said capacitor discharge welder to remove any paint from said painted metal panel and then weld said weld pin to said painted metal panel.

3. An apparatus for fastening insulation to a painted metal panel according to claim 1 wherein said ground clamp comprises a handle and first and second clamp ends, said first clamp end including a plastic member for ground and said second clamp end including a metal tip end adapted to either pass through an aperture in said painted metal panel and engage said plastic member or clamp to a portion of said painted metal panel.

4. An apparatus for fastening insulation to a painted metal panel according to claim 3 wherein said metal tip end has a knurled portion.

5. An apparatus for fastening insulation to a painted metal panel according to claim 4 wherein said plastic member of said ground clamp includes an aperture adapted to receive said metal tip end of said ground clamp.

6. An apparatus for fastening insulation to a painted metal panel according to claim 3 wherein a ground cable is attached to said second clamp end of said ground clamp.

7. An apparatus for fastening insulation to a painted metal panel according to claim 1 wherein said non-marring panel support is made of an ultra-high molecular weight plastic.

8. An apparatus for fastening insulation to a painted metal panel according to claim 1 wherein said hopper is a vibratory hopper.

9. An apparatus for fastening insulation to a painted metal panel according to claim 1 wherein said drive head includes a weld tip and said weld pin is a cupped weld pin having a cap with a dielectric coating on the underside of said cap and said weld tip and the upper portion of said cupped weld pin are adapted to nest together.

10. An apparatus for fastening insulation to a painted metal panel according to claim 1 wherein said painted metal panel is selected from the group consisting of an air conditioner panel, a furnace panel, an air handler panel and an insulated appliance panel.

11. A grounding clamp for use with an apparatus for fastening insulation to a painted metal panel comprising a handle and first and second clamp ends, said first clamp end including a plastic member for ground and said second clamp end including a metal tip end adapted to pass through an aperture in said painted metal panel and engage said plastic member or clamp to a portion of said painted metal panel.

12. A grounding clamp for use with an apparatus for fastening insulation to a painted metal panel according to claim 11 wherein said plastic member includes an aperture adapted to receive said metal tip end and wherein said metal tip end has a knurled portion.

13. A grounding clamp for use with an apparatus for fastening insulation to a painted metal panel according to claim 12 wherein a ground cable is attached to said second clamp end of said ground clamp.

14. A process for attaching insulation to a painted metal panel comprising the steps of (a) providing a painted metal panel with an unattached piece of insulation on a non-marring support member of an apparatus for fastening the insulation to the painted metal panel by a weld pin; (b) attaching a ground clamp to the painted metal panel or through an aperture in the painted metal panel, the ground clamp comprising a handle and first and second clamp ends, said first clamp end including a plastic member for ground and said second clamp end including a metal tip end adapted to pass through an aperture in said painted metal panel and engage said plastic member or clamp to a portion of said painted metal panel; (c) positioning the painted metal panel with the unattached piece of insulation under a drive head of the apparatus for fastening the insulation to the painted metal panel and which is connected to a capacitor discharge welder; (d) supplying a weld pin to the drive head of the apparatus; (e) welding the weld pin to the painted metal panel to fasten the insulation to the painted metal panel; and (f) repeating steps (a) through (e) a sufficient number of times to fasten the insulation to the painted metal panel, and wherein the fastening operation will not leave markings on the exterior side of the painted metal panel.

15. A process for attaching insulation to a painted metal panel according to claim 14 wherein said weld pin fastens said insulation to said painted metal panel in a two stage process comprising (a) punching the weld pin through the insulation and any paint on the painted metal panel and then contacting the painted metal panel and (b) said drive head puts pressure on said weld pin to seat said weld pin on said painted metal panel and receive two pulses from said capacitor discharge welder to remove any paint from said painted metal panel and then weld said weld pin to said painted metal panel.

16. A process for attaching insulation to a painted metal panel according to claim 14 wherein said plastic member of said ground clamp includes an aperture adapted to receive said metal tip end of said ground clamp.

17. A process for attaching insulation to a painted metal panel according to claim 14 wherein said painted metal panel is selected from the group consisting of an air conditioner panel, a furnace panel, an air handler panel and an insulated appliance panel.

18. A process for attaching insulation to a painted metal panel according to claim 14 wherein said drive head includes a weld tip and said weld pin is a cupped weld pin having a cap with a dielectric coating on the underside of said cap and said weld tip and the upper portion of said cupped weld pin are adapted to nest together.

19. An apparatus for fastening insulation to a painted metal panel, said apparatus comprising
a weld table,
a hopper for receiving weld pins connected to said weld table and a plurality of weld pins in said hopper,
a weld head connected to a capacitor discharge welder and connected to said weld table, said weld head adapted to position a weld pin through the insulation such that the weld pin is in contact with a painted metal panel to which the insulation is to be attached,
a ground clamp connected to said capacitor discharge welder and adapted to be connected to said painted metal panel,
a carriage connected to said weld table and which includes the weld head, a motor adapted to move the weld head the length of the carriage, and a motor adapted to move the carriage the length of the weld table, and
wherein a weld pin is supplied to said weld head and said weld head inserts said weld pin into said insulation and connects said insulation to said painted metal panel without marring the paint of said painted metal panel.

20. An apparatus for fastening insulation to a painted metal panel according to claim 19 wherein
said weld pin fastens said insulation to said painted metal panel in a two stage process comprising (a) punching the weld pin through the insulation and any paint on the painted metal panel and then contacting the metal panel and (b) said weld head puts pressure on said weld pin to seat said weld pin on said painted metal panel and to receive two pulses from said capacitor discharge welder to remove any paint from said painted metal panel and then weld said weld pin to said painted metal panel, and
said ground clamp comprises a handle and first and second clamp ends, said first clamp end including a plastic member for ground and said second clamp end including a metal tip end adapted to either pass through an aperture in said painted metal panel and engage said plastic member or clamp to a portion of said painted metal panel.
